(19) United States
(12) Patent Application Publication
(10) Pub. No.: US 2015/0154616 A1
(43) Pub. Date: Jun. 4, 2015

(54) METHOD AND SYSTEM FOR PROVIDING SERVICE FOR ANALYZING TECHNOLOGY MARKET THROUGH CONNECTION NETWORK FOR PRODUCT SUPPLY AND DEMAND

(71) Applicants: Jong Seok Kang, Goyang-si (KR); Hyuck Jai Lee, Seoul (KR); Byoung Yeol Go, Seoul (KR); Kang Hoe Kim, Seoul (KR); Hyun Sang Jung, Busan (KR); Yeong Ho Moon, Seoul (KR)

(72) Inventors: Jong Seok Kang, Goyang-si (KR); Hyuck Jai Lee, Seoul (KR); Byoung Yeol Go, Seoul (KR); Kang Hoe Kim, Seoul (KR); Hyun Sang Jung, Busan (KR); Yeong Ho Moon, Seoul (KR)

(73) Assignee: KOREA INSTITUTE OF SCIENCE AND TECHNOLOGY INFORMATION, Daejeon (KR)

(21) Appl. No.: 14/397,190

(22) PCT Filed: Jul. 25, 2012
(86) PCT No.: PCT/KR2012/005911

§ 371 Date: Oct. 25, 2014

(30) Foreign Application Priority Data
Jun. 21, 2012 (KR) 10-2012-0066614

(51) Int. Cl. G06Q 30/02

(52) U.S. Cl. CPC G06Q 30/0201

(57) ABSTRACT

The present invention relates to a method and system for providing a service for analyzing a technology market which, after analyzing the technology market by matching information for technology market analysis, such as patent information and trade information, chemistry information and manufacturing company information, with HS codes, and using a connection network for product supply and demand constructed in a hierarchical structure of a front-oriented supply and demand connection network or a rear-oriented supply and demand network, provides the traded state of corresponding products for each individual extension step, the traded state between a trade target and the corresponding products and uses defined for each area, the traded state of the products and uses corresponding to CAS numbers, and the analysis state of associated technology patents.

### TECHNICAL FIELD

The present invention relates to a technology market analysis service method and system using a product demand/supply connection network and, more particularly, to a technology market analysis service method and system using a product demand/supply connection network, wherein information for technology market analysis, such as trade information, chemistry information, and manufacturing company information, are matched with each other by Harmonized System (HS) codes, a technology market is analyzed using the product demand/supply connection network constructed in the form of the hierarchical structure of a forward-oriented demand/supply connection network so that it is revealed that what completed body has been made of the raw materials of a product or the hierarchical structure of a backward-oriented demand/supply connection network so that it is revealed that the completed body has been formed through which process, and the current trade situation of a corresponding product in each extension step and each corresponding use, the current trade situation of a corresponding product and use defined in each trade target and each region, the current trade situation of a corresponding product and use corresponding to each CAS number, and current technical patent-associated analysis situations are provided.

### BACKGROUND ART

Recently, as the use of the Internet is gradually expanded and communities within a space based on the Internet are formed, one of things that become more important is a technology for efficiently managing and integrating pieces of information and using the pieces of information.

Nevertheless, the mutual exchange of pieces information through the Internet has not been integrated and managed, but is managed by the efforts of respective sites, and only users who are aware of the sites or who have rights capable of accessing the sites are able to obtain information. Furthermore, information that may be obtained like so is not sufficiently obtained to the extent that the information is satisfactory due to the physical limit of a site user.

That is, a current knowledge sharing system is problematic in that the system is constructed using a conventional Internet method, that is, a web bulletin board, search is performed by people having rights capable of accessing the bulletin board only within a corresponding site, and retrieved contents are specifically limited depending on the task property of a corresponding site provider.

Knowledge provided through the Internet, however, is explosively increased along with the development of networks. Accordingly, in order to remove inefficiency and a high cost in efforts and costs required for a search process when knowledge required for a user is to be searched for, there is a strong need for a knowledge database that may be shared. In order to provide excellent content in such an environment, considerable expenses and human power must be invested systematically and designedly. There has been a need for an efficient system capable of constructing a database using content based on users' spontaneous participation.

Meanwhile, a database for implementing a product demand and supply connection network can be constructed by incorporating the use of an individual constructed product and the combinational and hierarchical characteristics of elements into the database. In a current IT level, attempts have been made at artificial intelligence and semantic technologies, but an example in which the database has been constructed is not present.

### DISCLOSURE

### Technical Problem

An object of the present invention for solving the aforementioned disadvantages is to provide a technology market analysis service method and system using a product demand/supply connection network, wherein information for technology market analysis, such as trade information, chemistry information, and manufacturing company information, are matched with each other by Harmonized System (HS) codes, a technology market is analyzed using the product demand/supply connection network constructed in the form of the hierarchical structure of the forward-oriented demand/supply connection network so that it is revealed that what completed body has been made of the raw materials of a product or the hierarchical structure of the backward-oriented demand/supply connection network so that it is revealed that the completed body has been formed through which process, and the current trade situation of a corresponding product in each extension step and each corresponding use, the current trade situation of a corresponding product and use defined in each trade target and each region, the current trade situation of a corresponding product and use corresponding to each CAS number, and current technical patent-associated analysis situations are provided.

### Technical Solution

In accordance with an aspect of the present invention for achieving the object, there is provided a technology market analysis service method using a product demand/supply connection network of a technology market analysis apparatus including a microprocessor that controls a product demand/supply connection network service, including the steps of (a) collecting, by the microprocessor, patent information, chemistry information, trade information, and company information and matching the pieces of information with each other by Harmonized System (HS) code numbers and Chemical

Abstract Service (CAS) registry numbers; (b) storing, by the microprocessor, the pieces of information matched with each other by the HS code numbers and the CAS numbers in a database for the product demand/supply connection network service in the form of the hierarchical structure of a forward-oriented or backward-oriented demand/supply connection network; (c) receiving a technology market analysis service according to the product demand/supply connection network from a user terminal; (d) classifying, by the microprocessor, a plurality of products of the demand/supply connection network into a first band to an N^{th} band according to technical application ranges corresponding to respective extension steps; and (e) providing, by the microprocessor, the user terminal with a current trade situation of a corresponding product in each extension step, a current trade situation of a corresponding product defined in each trade target and each region, a current trade situation of a product corresponding to each CAS number, and current technical patent analysis situations with respect to the plurality of products classified into the first band to the N^{th} band.

Furthermore, the step (a) may include collecting, by the microprocessor, the patent information from a patent information providing apparatus, the HS codes from a trade information providing apparatus, the CAS numbers from chemistry information providing apparatus, and the company information from a company information providing apparatus through an information collection unit and matching the patent information, the trade information, the chemistry information, and the company information with each other using the HS code numbers and the CAS registry numbers.

Furthermore, the step (d) may include classifying, by the microprocessor, the plurality of products into the first band to the N^{th} band according to the technical application ranges corresponding to the respective extension steps based on the hierarchical structure of the forward-oriented or backward-oriented demand/supply connection network.

Furthermore, the step (d) may include classifying, by the microprocessor, the plurality of products into the first band in which both an HS code number and a CAS number are present, the second band to which an initial part is transferred and in which only an HS code number is present, and the third band to the N^{th} band in which the part demand and supply system is defined and in which only an HS code number is present.

Furthermore, the step (d) may include providing, by the microprocessor, information about the amount of trade of export and import-related products, providing information about CAS numbers, technical patent numbers, and product regulations, or providing trade target countries and region-based items according to a combination of queries or a combination of words.

Meanwhile, in accordance with another aspect of the present invention for achieving the object, there is provided a technology market analysis service system using a product demand/supply connection network, including an information collection unit collecting pieces of information required for the product demand/supply connection network from a patent information providing apparatus, a trade information providing apparatus, a chemistry information providing apparatus, and a company information providing apparatus over a communication network; a data classification unit classifying the pieces of collected information into data sets based on HS codes; a connection network configuration generation unit generating items, classified into the data sets, in the form of the hierarchical structure of a forward-oriented or backward-oriented demand/supply connection network; a database storage space storing patent information fetched from the patent information providing apparatus, HS codes fetched from the trade information providing apparatus, CAS numbers fetched from the chemistry information providing apparatus, and company information fetched from the company information providing apparatus and storing information about the hierarchical structure of the forward-oriented or backward-oriented demand/supply connection network; and a service providing unit providing information about the amount of trade of export and import-related products, providing information about CAS numbers, technical patent numbers, and product regulations, and providing trade target countries and region-based items based on the hierarchical structure of the forward-oriented or backward-oriented demand/supply connection network.

Furthermore, the information collection unit may collect the trade information, including tariff-harmonized commodity classification codes (Harmonized System (HS) codes), from the trade information providing apparatus, the CAS numbers from the chemistry information providing apparatus, or information, including the company information, from the company information providing apparatus over the communication network.

Furthermore, the data classification unit may classify the pieces of collected information into the data sets according to regions, uses, and designated items.

Furthermore, the service providing unit may classify the pieces of collected information into the first band in which both an HS code number and a CAS number are present, the second band to which an initial part is transferred and in which only an HS code number is present, and the third band to the N^{th} band in which the part demand and supply system is defined and in which only an HS code number is present and may provide information about the amount of trade of export and import-related products, may provide information about CAS numbers, technical patent numbers, and product regulations, or may provide trade target countries and region-based items according to a combination of queries or a combination of words.

### Advantageous Effects

In accordance with the present invention, patent information, trade information, chemistry information, and manufacturing company information can be checked at a time over the product demand and supply connection network for a product to be searched for.

Furthermore, the current trade situation of a corresponding product in each extension step can be provided through the product demand/supply connection network, and a user can check the hierarchical structure of a forward-oriented or backward-oriented demand/supply connection network for a product to be searched for.

Furthermore, the current trade situation of a corresponding product defined in each trade target and each region and the technology market of a desired product can be checked through the product demand/supply connection network in association with technical patent analysis results.

Furthermore, information about the export and import of a desired product or information about a technical patent can be checked through the product demand/supply connection network in association with the current trade situation of a product corresponding to each CAS number and technical patent analysis results.

Furthermore, a current information situation and related industry technology information for the raw materials, intermediate body, and partial body of a product to be searched for and the completed body of the product can be quickly checked, and technical development and a market tendency can be easily checked.

### DESCRIPTION OF DRAWINGS

FIG. 1 is a block diagram illustrating an overall configuration of a technology market analysis service system using a product demand/supply connection network in accordance with an embodiment of the present invention.

FIG. 2 is a block diagram schematically illustrating the functions of a technology market analysis apparatus in accordance with an embodiment of the present invention.

FIG. 3 illustrates a flowchart for illustrating a technology market analysis service method using a product demand/supply connection network in the technology market analysis apparatus in accordance with an embodiment of the present invention.

FIG. 4 is a diagram illustrating an example in which patent information, chemistry information, trade information, and company information are matched with each other by HS codes in accordance with an embodiment of the present invention.

FIG. 5 is a diagram illustrating the hierarchical structure of a forward-oriented demand/supply connection network in accordance with an embodiment of the present invention.

FIG. 6 is a diagram illustrating the hierarchical structure of a backward-oriented demand/supply connection network in accordance with an embodiment of the present invention.

FIG. 7 is a diagram illustrating an example in which a plurality of products in a demand/supply connection network are classified into a first band to an N-th band according to technical application ranges corresponding to respective extension steps in accordance with an embodiment of the present invention.

FIG. 8 is a diagram illustrating criteria for classification into the first band to the N-th band in accordance with an embodiment of the present invention.

### BEST MODE

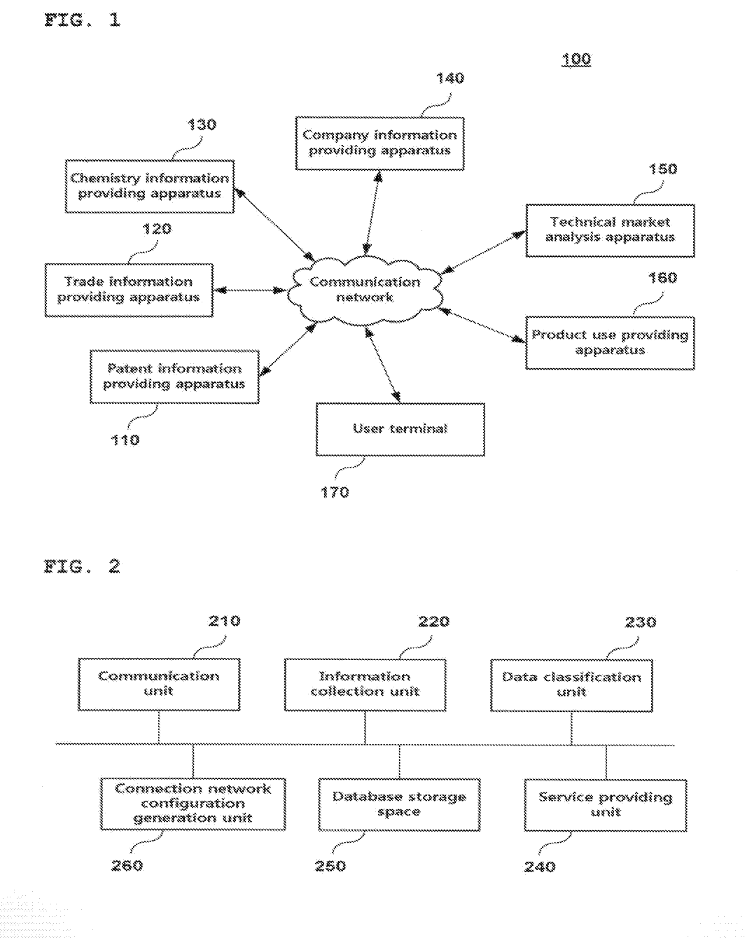

FIG. 1 is a block diagram illustrating an overall configuration of a technology market analysis service system using a product demand/supply connection network in accordance with an embodiment of the present invention.

Referring to FIG. 1, the product demand/supply connection network service system 100 based on tariff-harmonized commodity description codes in accordance with an embodiment of the present invention includes a patent information providing apparatus 110, a trade information providing apparatus 120, a chemistry information providing apparatus 130, a company information providing apparatus 140, a technology market analysis apparatus 150, a product use providing apparatus 160, and so on.

Furthermore, the technology market analysis apparatus 150 is an apparatus for constructing a product demand/supply connection network database in accordance with an embodiment of the present invention and providing analysis information associated with technology markets based on the constructed database. To this end, the technology market analysis apparatus 150 communicate with the patent information providing apparatus 110, the trade information providing apparatus 120, the chemistry information providing apparatus 130, and the company information providing apparatus 140 over a communication network.

In this case, the technology market analysis apparatus 150 fetches items based on tariff-harmonized commodity description codes from the trade information providing apparatus 120 over the communication network, classifies the fetched items into data sets based on Harmonized System (HS) codes, generates the items classified into the data sets in the form of the hierarchical structure of a forward-oriented or backward-oriented demand/supply connection network, and provides information about the amount of trade of export- and import-related products based on the hierarchical structure of the forward-oriented or backward-oriented demand/supply connection network, provides information about Chemical Abstract Service (CAS) registry numbers, technical patent numbers, and product regulations, or provides trade target countries and region-based items. In such a case, the technology market analysis apparatus 150 provides the information about the amount of trade of the export- and import-related products, provides the information about the CAS numbers, technical patent numbers, and product regulations, or provides the trade target countries and the region-based items according to a combination of queries or a combination of words.

In this case, the patent information providing apparatus 110 is an apparatus for providing information related to patent and may be a server computer for providing patent information by the Patent Office or a civilian organization in each country. In the case of the Republic of Korea, the patent information providing apparatus 110 may be KIPRIS or WIPS, for example.

Furthermore, the trade information providing apparatus 120 may be a server computer for providing information related to trade by a trade institution, trade research worker, trade organization, or trade association in each country, for example. In particular, the trade information providing apparatus 120 provides Harmonized System (HS) codes that are included in information related to trade and that are about trade products.

Furthermore, the chemistry information providing apparatus 130 may be a server computer for providing information related to chemistry by a chemical institution, chemical organization, chemistry research worker, or chemical association in each country, for example. In particular, the chemistry information providing apparatus 130 provides Chemistry Abstract Service (CAS) registry numbers that are included in information related to chemistry and that are about corresponding products.

Furthermore, the company information providing apparatus 140 may be a server computer for providing information related to a manufacturing company, for example, a company name, a foundation date, the number of employees, yearly sales, manufacturing items, and export items. An example of the company information providing apparatus 140 may be the server computer of a stock exchange that provides information about companies on list or KOSDAQ companies.

Furthermore, the technology market analysis apparatus 150 fetches patent information, trade information, chemistry information, and manufacturing company information over a communication network, matches the pieces of information with each other based on HS codes, stores the pieces of matched information in a database storage space in the form of the hierarchical structure of a forward-oriented or backward-oriented demand/supply connection network, and constructs the product demand/supply connection network database into which the use of products and the combinational and hierarchical characteristics of components have been incorporated. Furthermore, when a technology market analysis service is received from the user terminal 170 over the product demand/supply connection network, the technology market analysis apparatus 150 classifies a plurality of products in the demand/supply connection network into a first band to an N-th band according to technical application ranges corresponding to respective extension steps, and provides the user terminal 170 with the current trade situation of a corresponding product in each extension step, the current trade situation of a corresponding product defined in each trade target and each region, the current trade situation of product corresponding to each CAS number, and current technical patent analysis situations with respect to the plurality of products classified into the first band to the N-th band.

Furthermore, the product use providing apparatus 160 is an apparatus for providing products manufactured by manufacturing companies or the use of products distributed by distribution companies. The product use providing apparatus 160 may fetch the use of each product from a server or institution in technical association with the server or institution that provides the use of the product and may provide the use of each product to the technology market analysis apparatus 150.

Furthermore, the user terminal 170 may be a computer terminal and may be a mobile terminal using a mobile communication network.

Furthermore, the communication network may include all of a wired communication network including the Internet, a mobile communication network, such as WCDMA or LTE, and a short-distance communication network, such as ZigBee or Wi-Fi.

### Mode for Invention

FIG. 2 is a block diagram schematically illustrating the functions of the technology market analysis apparatus in accordance with an embodiment of the present invention.

Referring to FIG. 2, the technology market analysis apparatus 150 in accordance with an embodiment of the present invention includes a communication unit 210, an information collection unit 220, a data classification unit 230, a connection network configuration generation unit 240, a database storage space 250, a service providing unit 260, and so on.

The communication unit 210 is a hardware element responsible for a communication function for communication with the patent information providing apparatus 110, the trade information providing apparatus 120, the chemistry information providing apparatus 130, and the company information providing apparatus 140 over the communication network.

The information collection unit 220 collects pieces of related information required for a product demand/supply connection network from the patent information providing apparatus 11, the trade information providing apparatus 120, the chemistry information providing apparatus 130, and the company information providing apparatus 140 over the communication network.

That is, the information collection unit 220 collects pieces of trade information including tariff-harmonized commodity description codes (i.e., harmonized system codes) from the trade information providing apparatus 120 over the communication network. Furthermore, the information collection unit 220 may collect CAS numbers from the chemistry information providing apparatus 130 and collect pieces of manufacturing company information from the company information providing apparatus 140.

Next, the data classification unit 230 classifies pieces of collected information into data sets based on HS codes. For example, the data classification unit 230 may fetch items based on tariff-harmonized commodity description codes from trade information and classify the fetched items into data sets based on HS codes. In this case, the data classification unit 230 may classify the fetched items into data sets according to regions, uses, and designated items.

Next, the connection network configuration generation unit 240 generates the items classified into the data sets in the form of the hierarchical structure of a forward-oriented or backward-oriented demand/supply connection network. In this case, the connection network configuration generation unit 240 may generate the items classified into the data sets in the form of a hierarchical structure in which a forward-oriented or backward-oriented demand/supply connection network can be selected.

In this case, the hierarchical structure of the forward-oriented demand/supply connection network is a structure in which the items of a product are connected from raw materials to a completed body through a process of the intermediate body of the product (the partial body of the product) and may be said to be a structure that reveals that what completed body has been formed by the raw materials of a product.

Furthermore, the hierarchical structure of the backward-oriented demand/supply connection network is a concept opposite to that of the forward-oriented meaning and may be said to be a structure that reveals that the completed body of the items of a product has been formed through which process.

The database storage space 250 stores the patent information fetched from the patent information providing apparatus 110, the HS codes fetched from the trade information providing apparatus 120, the CAS numbers fetched from the chemistry information providing apparatus 130, and the manufacturing company information fetched from the company information providing apparatus 140 over the communication network and also stores information about the hierarchical structure of the forward-oriented or backward-oriented demand/supply connection network.

The service providing unit 260 is a hardware element for controlling technology market analysis services using the product demand/supply connection network according to the present invention and may be implemented using a microprocessor, for example. The service providing unit 260 provides information about the amount of trade of export- and import-related products, provides information about CAS numbers, technical patent numbers, and product regulations, or provides trade target countries and region-based items based on the hierarchical structure of the forward-oriented or backward-oriented demand/supply connection network.

Furthermore, the service providing unit 260 may provide the information about the amount of the trade of export- and import-related products, may provide the information about the CAS numbers, technical patent numbers, and product regulations, or may provide the trade target countries and the region-based items according to a combination of queries or a combination of words.

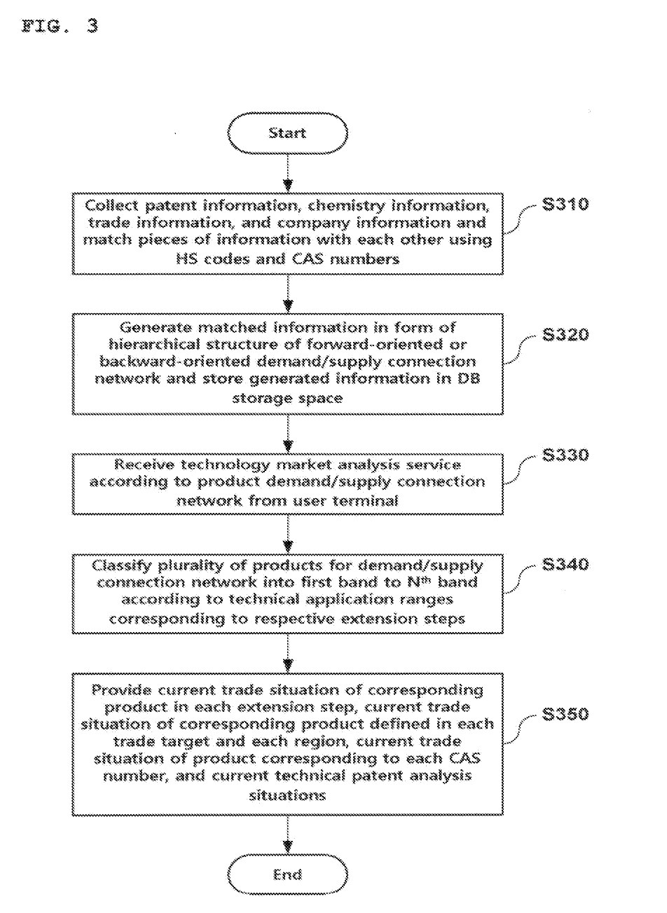

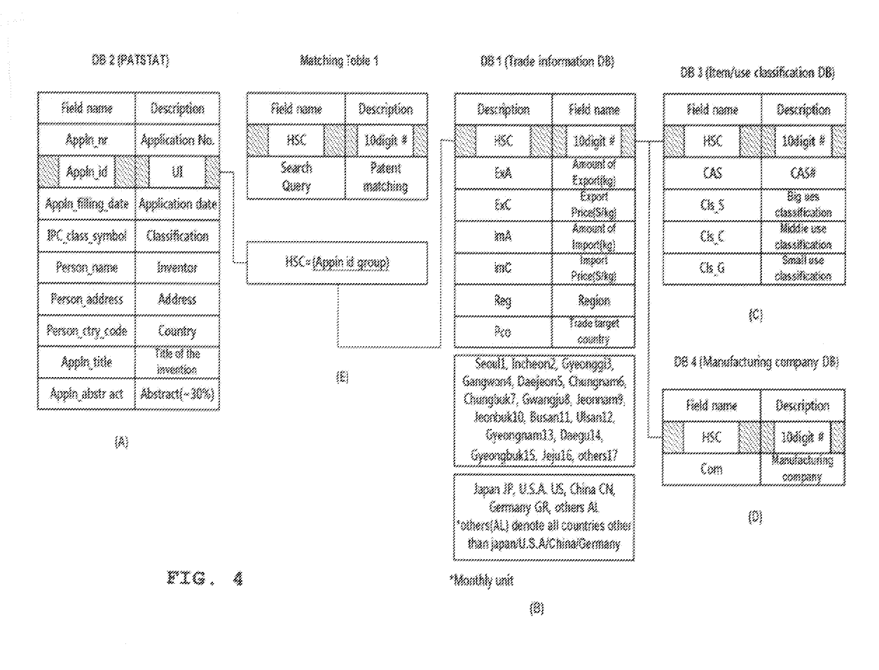

FIG. 3 illustrates a flowchart for illustrating technology market analysis service method using a product demand/supply connection network in the technology market analysis apparatus in accordance with an embodiment of the present invention.

Referring to FIG. 3, the service providing unit 260, that is, a microprocessor, of the technology market analysis apparatus 150 in accordance with an embodiment of the present invention collects patent information, chemistry information, trade information, and company information over the communication network and matches the pieces of information with each other using HS codes and CAS numbers (S310).

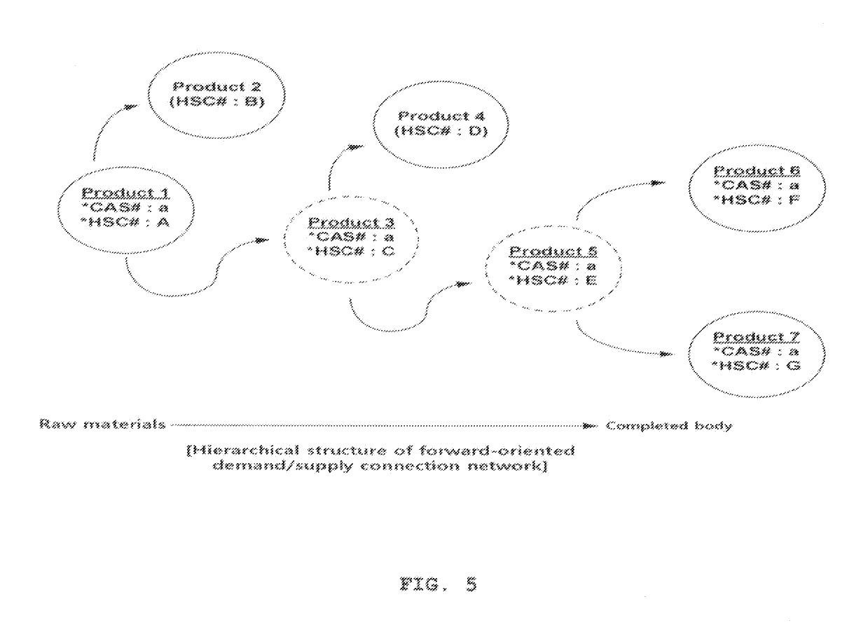

That is, in order to provide a product demand/supply connection network service, the service providing unit 260 of the technology market analysis apparatus 150 may fetch trade information B about a product, including an HS code, the amount of export, an export price, the amount of import, an import price, an area, a trade target country, and each regional name, from the trade information providing apparatus 120, may fetch patent information A about the product, including an application No., an applicant, an application date, IPC classification, an inventor, an address, a country, the title of the invention, and an abstract, from the patent information providing apparatus 110, may fetch chemistry information C about the product, including a CAS number, big use classification, middle use classification, and small use classification, from the chemistry information providing apparatus 130, and may fetch pieces of information D about each company from the company information providing apparatus 140. FIG. 4 is a diagram illustrating an example in which the patent information, the chemistry information, the trade information, and the company information are matched with each other by HS codes in accordance with an embodiment of the present invention. Furthermore, the service providing unit 260 matches the patent information, the chemistry information, the trade information, and the company information using the HS codes and the CAS numbers, as illustrated in FIG. 4.

Next, as illustrated in FIG. 4, the service providing unit 260 generates the information, matched with each other by the HS codes and the CAS numbers, in the form of the hierarchical structure of a forward-oriented demand/supply connection network or the hierarchical structure of a backward-oriented demand/supply connection network and stores the generated information in the database storage space 250 for product demand/supply connection network services (S320).

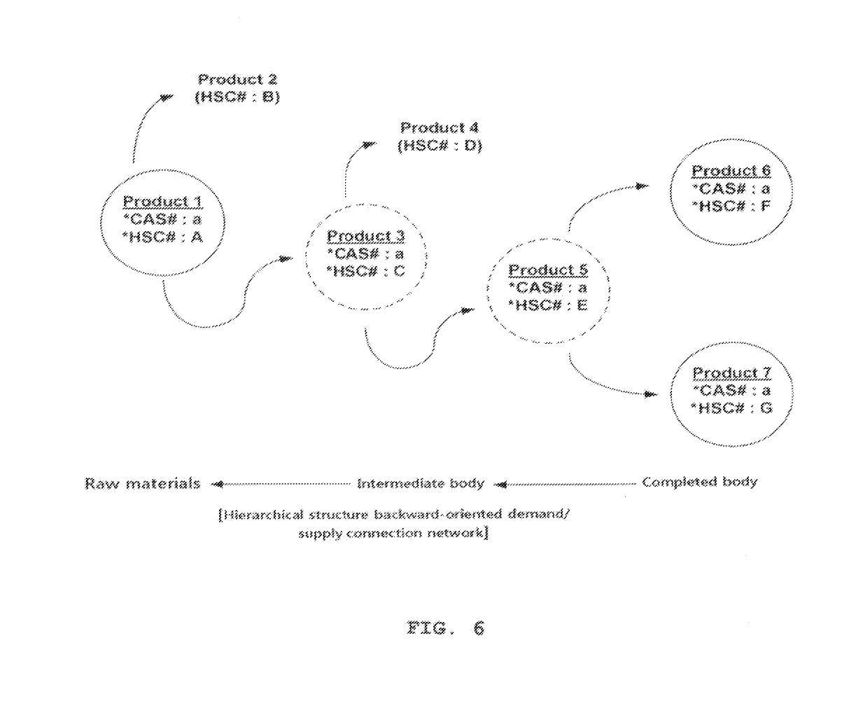

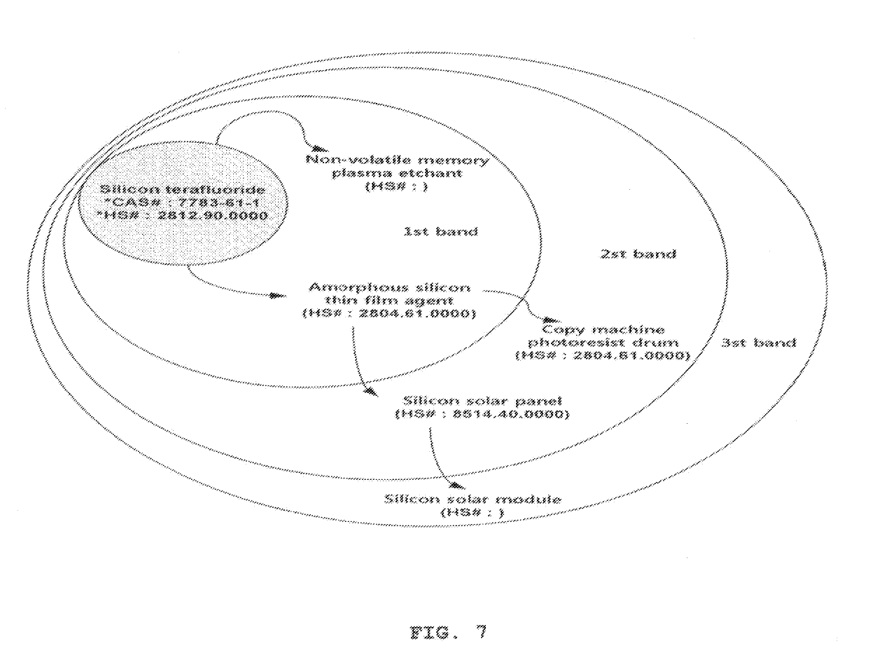

That is, the service providing unit 260 generates the patent information, the trade information, the chemistry information, and the company information, matched with each other by the HS codes and the CAS numbers as illustrated in FIG. 4, in the form of the hierarchical structure of the forward-oriented demand/supply connection network as illustrated in FIG. 5 or the hierarchical structure of the backward-oriented demand/supply connection network as illustrated in FIG. 6 and stores the pieces of information in the database.

In this case, as illustrated in FIG. 5, in the hierarchical structure of the forward-oriented demand/supply connection network, the items of a product is connected from raw materials to a completed body via a process of the intermediate body (i.e., the partial body) of the product, thus revealing that what completed body has been finally formed by the raw materials of the product. FIG. 5 is a diagram illustrating the hierarchical structure of the forward-oriented demand/supply connection network in accordance with an embodiment of the present invention. As illustrated in FIG. 5, in the hierarchical structure of the forward-oriented demand/supply connection network, it may be understood that, for example, Product 2 having an HS code number HSC# of ‘B’ has been completed from a raw material product Product 1 having an HS code number HSC# of ‘A’, Product 4 having an HS code number HSC# of ‘D’ has been completed from the Product 1 having the HS code number HSC# of ‘A’ corresponding to raw materials, and Product 6 having an HS code number HSC# of ‘F’ has been completed from the Product 1 having the HS code number HSC# of ‘A’. Likewise, it may be understood that Product 7 having an HS code number HSC# of ‘G’ has also been completed from the Product 1 having the HS code number HSC# of ‘A’ corresponding to raw materials.

Meanwhile, as illustrated in FIG. 6, the hierarchical structure of the backward-oriented demand/supply connection network illustrates a structure that reveals that a completed body has been formed through which process in a direction opposite to the connection direction of the forward-oriented hierarchical structure. FIG. 6 is a diagram illustrating the hierarchical structure of the backward-oriented demand/supply connection network in accordance with an embodiment of the present invention. As illustrated in FIG. 6, in the hierarchical structure of the backward-oriented demand/supply connection network, it may be understood that, for example, Product 6 having an HS code number HSC# of ‘F’ has been completed from Product 1 that corresponds to raw materials and that has an HS code number HSC# of ‘A’ via Product 5 HSC#:E and Product 3 HSC#:C corresponding to intermediate bodies. Likewise, it may also be understood that Product 7 having an HS code number HSC# of ‘G’ has been completed from the Product 1 that corresponds to raw materials and that has the HS code number HSC# of ‘A’ via the Product 5 HSC#:E and the Product 3 HSC#:C corresponding to intermediate bodies.

Next, when a user or an administrator requests technology market analysis service using the user terminal 170, the technology market analysis apparatus 150 receives the technology market analysis service according to the product demand/supply connection network from the user terminal 170 (S330).

In response to the request, the service providing unit 260 of the technology market analysis apparatus 150 classifies a plurality of products for the demand/supply connection network into a first band to an N^{th} band according to technical application ranges corresponding to respective extension steps based on the hierarchical structure of the forward-oriented or backward-oriented demand/supply connection network (S340), as illustrated in FIG. 7. FIG. 7 is a diagram illustrating an example in which a plurality of products in a demand/supply connection network are classified into the first band to the N^{th} band according to technical application ranges corresponding to respective extension steps in accordance with an embodiment of the present invention.

That is, as illustrated in FIG. 7, the service providing unit 260 may divide, for example, a product “silicon tetrafluoride”, having an HS code “2812.90.0000” and a CAS number “7783-61-1”, into a non-volatile memory plasma etchant and an amorphous silicon thin film agent (HS#:2804.61.0000) in the first band, may divide the product into a copy machine photoresist drum (HS#:2804.61.0000) and a silicon solar panel (HS#:8541.40.0000) in the second band, and may sort the product as a silicon solar module (HS#:) in the third band based on the hierarchical structure of the forward-oriented demand/supply connection network.

Furthermore, as illustrated in FIG. 4, the service providing unit 260 uses a database in which the trade information, the chemistry information, the patent information, and the company information have been matched with each other by the HS codes and constructed. The patent information includes an application No., an applicant, an application date, IPC classification, an inventor, an address, a country, the title of the invention, an abstract, etc. The trade information includes the amount of export, an export price, the amount of import, an import price, a region, a trade target country, etc. The chemistry information includes a CAS number, big use classification, middle use classification, small use classification, etc.

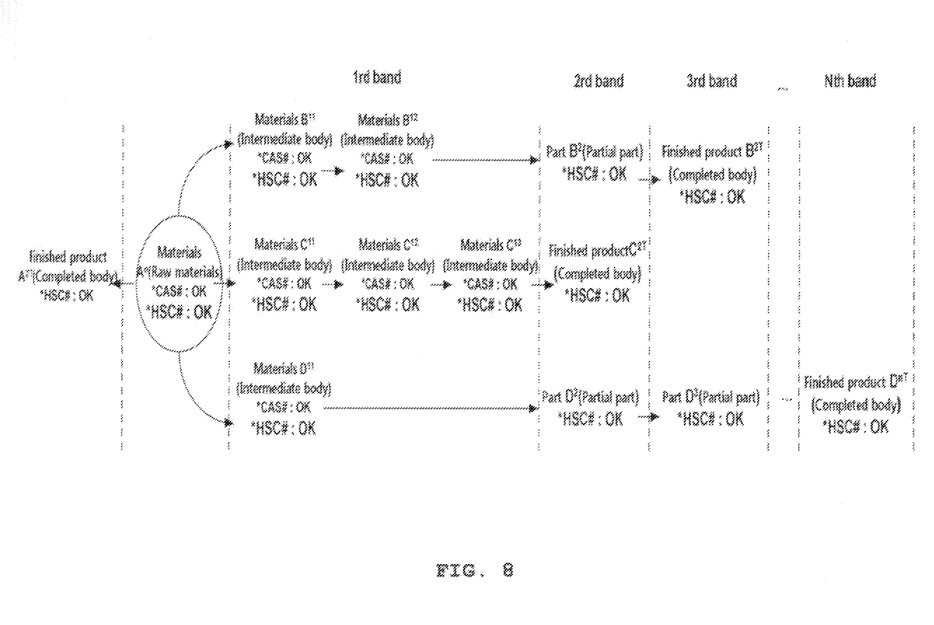

In this case, as illustrated in FIG. 8, the service providing unit 260 may classify a plurality of products into the first band in which both an HS code number and a CAS number are present, the second band to which an initial part is transferred and in which only an HS code number is present, and the third band to the N^{th} band in which a part demand and supply system is defined and in which only an HS code number is present in accordance with a material-based demand and supply system. FIG. 8 is a diagram illustrating criteria for classification into the first band to the N^{th} band in accordance with an embodiment of the present invention.

Furthermore, the service providing unit 260 provides the user terminal 170 with the current trade situation of a corresponding product in each extension step, the current trade situation of a corresponding product defined in each trade target and each region, the current trade situation of a product corresponding to each CAS number, and current technical patent analysis situations of the plurality of products classified into the first band to the N^{th} band (S350).

Furthermore, the service providing unit 260 provides information about the amount of trade of export- and import-related products, provides information about CAS numbers, technical patent numbers, and product regulations, or provides trade target countries and region-based items technology market analysis results using the aforementioned database based on the hierarchical structure of the forward-oriented or backward-oriented demand/supply connection network.

As described above, in accordance with the present invention, patent information, the technology market analysis service method and system using the product demand/supply connection network can be achieved in which information for technology market analysis, such as trade information, chemistry information, and manufacturing company information, are matched with each other by HS codes, a technology market is analyzed using the product demand/supply connection network constructed in the form of the hierarchical structure of the forward-oriented demand/supply connection network so that it is revealed that what completed body has been made of the raw materials of a product or the hierarchical structure of the backward-oriented demand/supply connection network so that it is revealed that the completed body has been formed through which process, and the current trade situation of a corresponding product in each extension step and each corresponding use, the current trade situation of a corresponding product and use defined in each trade target and each region, the current trade situation of a corresponding product and use corresponding to each CAS number, and current technical patent-associated analysis situations are provided.

Those skilled in the art to which the present invention pertains will understand that the present invention may be implemented in various detailed forms without changing the technical spirit or indispensable characteristics of the present invention. It will be understood that the aforementioned embodiments are illustrative and not limitative from all aspects. The scope of the present invention is defined by the appended claims rather than the detailed description, and the present invention should be construed as covering all modifications or variations derived from the meaning and scope of the appended claims and their equivalents.

### INDUSTRIAL APPLICABILITY

The present invention may be applied to a technology market analysis service method and system using a product demand/supply connection network, wherein information for technology market analysis, such as trade information, chemistry information, and manufacturing company information, are matched with each other by HS codes, a technology market is analyzed using the product demand/supply connection network constructed in the form of the hierarchical structure of the forward-oriented demand/supply connection network so that it is revealed that what completed body has been made of the raw materials of a product or the hierarchical structure of the backward-oriented demand/supply connection network so that it is revealed that the completed body has been formed through which process, and the current trade situation of a corresponding product in each extension step and each corresponding use, the current trade situation of a corresponding product and use defined in each trade target and each region, the current trade situation of a corresponding product and use corresponding to each CAS number, and current technical patent-associated analysis situations are provided.

1. A technology market analysis service method using a product demand/supply connection network of a technology market analysis apparatus comprising a microprocessor that controls a product demand/supply connection network service, the method comprising steps of:
(a) collecting, by the microprocessor, patent information, chemistry information, trade information, and company information and matching the pieces of information with each other by Harmonized System (HS) code numbers and Chemical Abstract Service (CAS) registry numbers;
(b) storing, by the microprocessor, the pieces of information matched by the HS code numbers and the CAS numbers in a database for the product demand/supply connection network service in a form of a hierarchical structure of a forward-oriented or backward-oriented demand/supply connection network;
(c) receiving a technology market analysis service according to the product demand/supply connection network from a user terminal;
(d) classifying, by the microprocessor, a plurality of products of the demand/supply connection network into a first band to an N^{th} band according to technical application ranges corresponding to respective extension steps; and
(e) providing, by the microprocessor, the user terminal with a current trade situation of a corresponding product in each extension step, a current trade situation of a corresponding product defined in each trade target and each region, a current trade situation of a product corresponding to each CAS number, and current technical patent analysis situations with respect to the plurality of products classified into the first band to the N^{th} band.

2. The technology market analysis service method of claim 1, wherein the step (a) comprises collecting, by the microprocessor, the patent information from a patent information providing apparatus, the HS codes from a trade information providing apparatus, the CAS numbers from a chemistry information providing apparatus, and the company information from a company information providing apparatus through an information collection unit and matching the patent information, the trade information, the chemistry information, and the company information with each other using the HS code numbers and the CAS registry numbers.

3. The technology market analysis service method of claim 1, wherein the step (d) comprises classifying, by the microprocessor, the plurality of products into the first band to the N^{th} band according to the technical application ranges corresponding to the respective extension steps based on the hierarchical structure of the forward-oriented or backward-oriented demand/supply connection network.

4. The technology market analysis service method of claim 1, wherein the step (d) comprises classifying, by the microprocessor, the plurality of products into the first band in which both an HS code number and a CAS number are present, the second band to which an initial part is transferred and in which only an HS code number is present, and the third band to the N^{th} band in which the part demand and supply system is defined and in which only an HS code number is present.

5. The technology market analysis service method of claim 1, wherein the step (d) comprises providing, by the microprocessor, information about an amount of trade of export and import-related products, providing information about CAS numbers, technical patent numbers, and product regulations, or providing trade target countries and region-based items according to a combination of queries or a combination of words.

6. A technology market analysis service system using a product demand/supply connection network, comprising:
an information collection unit collecting pieces of information required for the product demand/supply connection network from a patent information providing apparatus, a trade information providing apparatus, a chemistry information providing apparatus, and a company information providing apparatus over a communication network;
a data classification unit classifying the pieces of collected information into data sets based on HS codes;
a connection network configuration generation unit generating items, classified into the data sets, in a form of a hierarchical structure of a forward-oriented or backward-oriented demand/supply connection network;
a database storage space storing patent information fetched from the patent information providing apparatus, HS codes fetched from the trade information providing apparatus, CAS numbers fetched from the chemistry information providing apparatus, and company information fetched from the company information providing apparatus and storing information about the hierarchical structure of the forward-oriented or backward-oriented demand/supply connection network; and
a service providing unit providing information about an amount of trade of export and import-related products, providing information about CAS numbers, technical patent numbers, and product regulations, and providing trade target countries and region-based items based on the hierarchical structure of the forward-oriented or backward-oriented demand/supply connection network.

7. The technology market analysis service system of claim 6, wherein the information collection unit collects the trade information, comprising tariff-harmonized commodity classification codes (Harmonized System (HS) codes), from the trade information providing apparatus, the CAS numbers from the chemistry information providing apparatus, or information, comprising the company information, from the company information providing apparatus over the communication network.

8. The technology market analysis service system of claim 6, wherein the data classification unit classifies the pieces of collected information into the data sets according to regions, uses, and designated items.

9. The technology market analysis service system of claim 6, wherein the service providing unit classifies the pieces of collected information into the first band in which both an HS code number and a CAS number are present, the second band to which an initial part is transferred and in which only an HS code number is present, and the third band to the N^{th} band in which the part demand and supply system is defined and in which only an HS code number is present and provides information about an amount of trade of export and import-related products, provides information about CAS numbers, technical patent numbers, and product regulations, or provides trade target countries and region-based items according to a combination of queries or a combination of words.
